(19) United States
(12) Patent Application Publication
(10) Pub. No.: US 2025/0259382 A1
(43) Pub. Date: Aug. 14, 2025

(54) INFORMATION PROCESSING APPARATUS SETTING PLAY AREA ON VIRTUAL SPACE, INFORMATION PROCESSING METHOD, AND STORAGE MEDIUM

(71) Applicant: CANON KABUSHIKI KAISHA, Tokyo (JP)

(72) Inventors: KOUSHI TAKEMURA, Kanagawa (JP); WENJING LI, Tokyo (JP)

(21) Appl. No.: 19/045,733

(22) Filed: Feb. 5, 2025

(30) Foreign Application Priority Data
Feb. 8, 2024 (JP) 2024-017795

(51) Int. Cl. G06T 17/00; A63F 13/52; G06F 3/01

(52) U.S. Cl. CPC G06T 17/00; A63F 13/52; G06F 3/011

(57) ABSTRACT

An information processing apparatus capable of avoiding collision with an obstacle in a real space when a user wearing an HMD plays a game in a play area on a virtual space. The information processing apparatus displays a virtual space on a head mounted display worn by a user, detects position information of the user in the virtual space as a first user position, detects posture information of the user in the virtual space as a first user posture, sets a play area on the basis of the first user position and the first user posture, detects an obstacle in a real space in the play area, searches for a new play area on the basis of a position of the detected obstacle, and displays the new play area on the head mounted display.

### BACKGROUND OF THE INVENTION

### Field of the Invention

The present invention relates to an information processing apparatus, an information processing method, and a storage medium.

### Description of the Related Art

Recently, a technology called virtual reality (VR) in which immersion in a virtual space created by a computer different from reality is experienced has been widely used, and there are many contents to which the VR technology is applied. For example, a user wears a head mounted display (HMD) on his/her head, views a screen displayed on the HMD, and operates a controller or the like to play a game. When the HMD is worn in this way, the real world becomes invisible, and thus a user's sense of immersion in a virtual space increases. Furthermore, a content of playing a sport battle by displaying a remote user or a non player character (NPC) in the HMD is also provided, and a user wearing an HMD can also play a game in a play area set on the virtual space.

Thus, for example, Japanese Laid-Open Patent Publication (kokai) No. 2013-257716 discloses a technique for avoiding a situation in which a user collides with an obstacle in the real space when the user wears an HMD and enjoys a virtual space. For example, when a user is wearing an HMD and playing a shooting game, there may be an obstacle immediately in front of the user's body in the real space. In such a case, a fence is displayed immediately in front of the user as a virtual object with which the obstacle is replaced so that the user does not push the controller forward or move the body forward.

However, in the technique in Japanese Laid-Open Patent Publication (kokai) No. 2013-257716, when there is an obstacle immediately in front of a user in the real space, a virtual object with which the obstacle is replaced is displayed in a play area, and the user cannot freely move around in the play area.

### SUMMARY OF THE INVENTION

The present invention provides an information processing apparatus, an information processing method, and a storage medium capable of avoiding collision with an obstacle in a real space when a user wearing an HMD plays a game in a play area on a virtual space.

According to an aspect of the invention, the present invention provides an information processing apparatus that displays a virtual space on a head mounted display worn by a user, the information processing apparatus comprising one or more processors and/or circuitry configured to execute a first detection process of detecting position information of the user in the virtual space as a first user position, execute a second detection process of detecting posture information of the user in the virtual space as a first user posture, execute a play area setting process of setting a play area on the basis of the first user position and the first user posture, execute an obstacle detection process of detecting an obstacle in a real space in the play area, execute a search process of searching for a new play area on the basis of a position of the detected obstacle, and execute a notification process of displaying the new play area on the head mounted display.

According to the present invention, it is possible to avoid collision with an obstacle in a real space when a user wearing an HMD plays a game in a play area on a virtual space.

Further features of the present invention will become apparent from the following description of exemplary embodiments (with reference to the attached drawings).

### BRIEF DESCRIPTION OF THE DRAWINGS

FIG. 1 is a block diagram showing a hardware configuration example of an information processing apparatus according to a first embodiment of the present invention.

FIG. 2 is a block diagram showing a functional configuration according to the first embodiment of the present invention included in the information processing apparatus.

FIG. 3 is a diagram showing an example of an obstacle and a play area in a two-dimensional space.

FIG. 4 is a flowchart showing a play area search process according to the first embodiment of the present invention.

FIG. 5 is a diagram for describing a specific example of the play area search process in FIG. 4.

FIG. 6A is a diagram showing an example of HMD display in a case where there is no obstacle at an initial position of a user in the play area search process in FIG. 4.

FIG. 6B is a diagram showing an example of HMD display in a case where a new play area is found in the play area search process in FIG. 4.

FIG. 6C is a diagram showing an example of HMD display in a case where a new play area is found in the play area search process in FIG. 4.

FIG. 7 is a diagram showing an example of HMD display in a case where a new play area is not found in the play area search process in FIG. 4.

FIG. 8 is a diagram showing an example of an obstacle and a play area in a three-dimensional space.

FIG. 9 is a block diagram showing a functional configuration according to a second embodiment of the present invention included in the information processing apparatus.

FIG. 10 is a flowchart showing a play area search process according to the second embodiment of the present invention.

FIG. 11 is a diagram showing an example of a portable obstacle and a play area in a three-dimensional space.

FIG. 12 is a diagram showing an example of HMD display in a case where a portable obstacle is found in a play area in the play area search process in FIG. 10.

### DESCRIPTION OF THE EMBODIMENTS

Hereinafter, embodiments according to the present invention will be described with reference to the drawings. A configuration of each of the following embodiments can be modified or changed as appropriate according to specifications of a device to which the present invention is applied and various conditions (usage conditions, usage environment, and the like). In addition, some of the embodiments described later may be combined as appropriate. In the following embodiments, the same constituents are indicated by the same reference numerals.

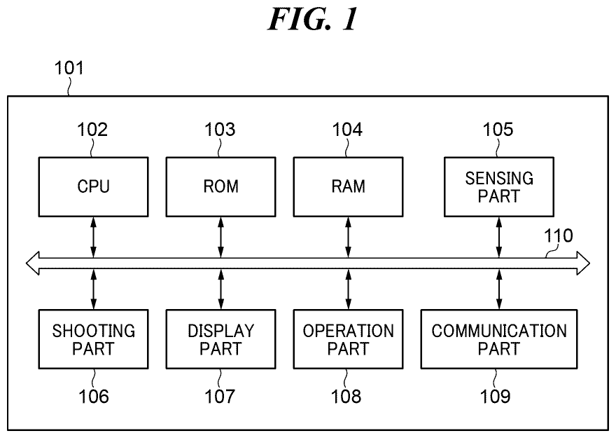

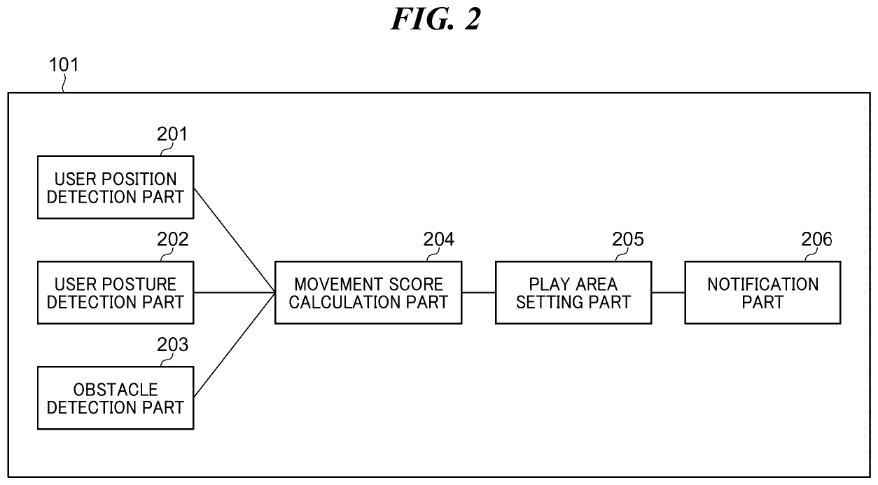

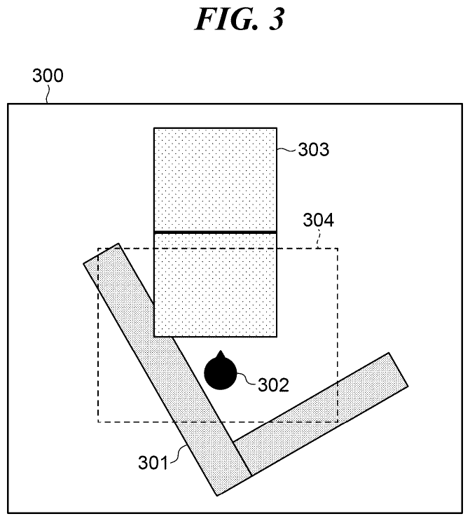

FIG. 1 is a block diagram showing a hardware configuration example of an information processing apparatus 101 according to a first embodiment of the present invention. FIG. 2 is a block diagram showing a functional configuration of the information processing apparatus 101 according to the first embodiment of the present invention. FIG. 3 is a diagram showing an example of an obstacle and a play area in a two-dimensional space.

First, an example of resetting a play area in a virtual space will be described with reference to FIG. 3. Here, as an example, a scene in which a user plays VR table tennis at home will be described. However, it is sufficient that a VR content (sports, a game, or training) is started at home or the like, and a VR content to which the present invention is applied is not limited to VR table tennis.

FIG. 3 is a diagram showing an example of an obstacle and a play area in a two-dimensional space.

FIG. 3 shows a disposition example of a wall 301 in a real space, a user 302 who experiences a VR content, a virtual table tennis table 303, and a play area 304 before the play area is reset.

The play area 304 is defined in advance according to a size depending on the type of VR content or the number of players. In FIG. 3, the play area 304 indicates a movement range of the user of a singles game in VR table tennis.

It should be noted that although the user 302 cannot see the wall 301 in the real space since the user 302 wears a head mounted display (HMD), the HMD worn by the user 302 has a function of acquiring position/posture information of the wall 301 and the user 302. Therefore, the HMD can obtain obstacle information indicating a positional relationship between the wall 301 and the play area 304. Furthermore, the HMD can reflect movement similar to the movement of the user 302 in the real space on an avatar of the user in the virtual space.

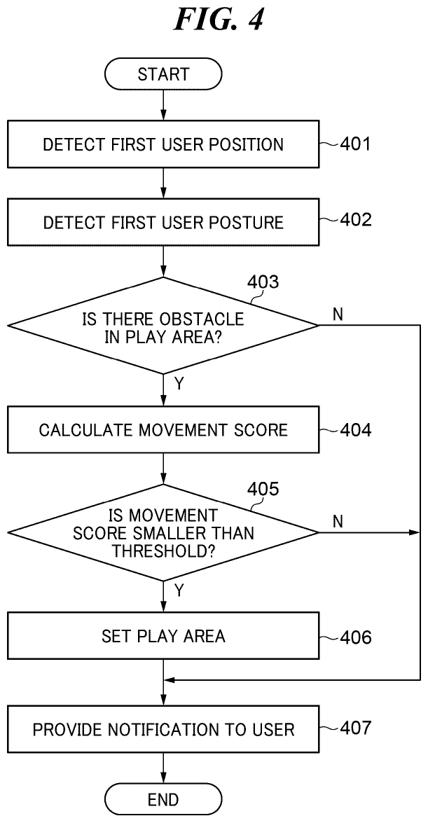

In a case where there is an obstacle in the play area 304 in the real space, first, the information processing apparatus 101 resets a new play area according to the position/posture information of the user 302 and the obstacle information of the obstacle (wall 301) in the real space present in the play area 304. Thereafter, the new play area is displayed on the HMD. Specifically, the HMD display will be described in a play area search process that will be described later with reference to a flowchart of FIG. 4.

Since the user 302 performs VR table tennis at home, a space that can be set as the play area 304 in the real space is limited. However, since the user 302 wearing the HMD cannot see the real space, it is difficult for the user himself/herself to recognize the obstacle (wall 301) in the real space. Therefore, when the user 302 starts the VR content in the play area 304 set according to a position of the user 302 (hereinafter, referred to as a first user position) in the real space, the wall 301 is present in the play area 304. Thus, the user 302 may contact the wall 301 during gameplay.

Therefore, in the present embodiment, the information processing apparatus 101 performs a play area search process that will be described later so that the user can play the game safely without coming into contact with an obstacle. Specifically, in the present embodiment, the information processing apparatus 101 sets a new play area on the basis of the position/posture information of the user who experiences the VR content and the obstacle information in the real space, and presents (HMD display) the play area to the user. As a result, the user can safely play the game without coming into contact with the obstacle in the set new play area simply by the user moving to a position of the user (hereinafter, referred to as a second user position) in the new play area.

Next, a hardware configuration of the information processing apparatus 101 will be described with reference to FIG. 1.

Hereinafter, the user before resetting the play area will be referred to as a first user, and the user after resetting the play area will be referred to as a second user.

The information processing apparatus 101 is an HMD worn by the first user and is connected to an external PC. However, the information processing apparatus 101 may be any electronic apparatus that can communicate with and control the HMD worn by the first user, and may be, for example, a PC to which the HMD worn by the first user is connected. The information processing apparatus 101 includes, as constituents, a CPU 102, a ROM 103, a RAM 104, a sensing part 105, a shooting part 106, a display part 107, an operation part 108, and a communication part 109. The respective constituents are connected to each other via a bus 110.

The CPU 102 is an arithmetic processing unit that integrally controls the information processing apparatus 101. The CPU 102 executes various programs stored in the ROM 103 or the like to perform various processes.

The ROM 103 is a read-only nonvolatile memory device that stores programs (image processing programs, initial data, and the like) and parameters that do not need to be changed.

The RAM 104 temporarily stores input information, calculation results in image processing, and the like. The RAM 104 is a memory device that provides the CPU 102 with a work area.

The sensing part 105 is a device such as a sensor, and acquires position/posture information of the user by detecting rotation, inclination, and a movement amount of the head of the user wearing the information processing apparatus 101 that is an HMD.

The shooting part 106 is a shooting device including a built-in camera of the information processing apparatus 101 that is an HMD, and performs a shooting process. For example, the shooting part 106 detects a position of the hand of the user wearing the information processing apparatus 101 (hand tracking). Note that, in a case where the information processing apparatus 101 is a PC connected to the HMD worn by the user, an externally connected web camera or the like functions as the shooting part 106.

The display part 107 includes a liquid crystal display or the like, and displays a picked-up image, a virtual object, text, and/or an item (icon; content) to the user wearing the information processing apparatus 101 that is an HMD.

The operation part 108 is an operation unit including an operation member such as a power button or a dial.

The communication part 109 transmits and receives data to and from an external device through wired communication or wireless communication (wireless LAN, local 5G, or the like). Examples of the external device include an external controller (not shown) held by the user wearing the information processing apparatus 101. Note that, in a case where the information processing apparatus 101 is a PC connected to the HMD worn by the user, the communication part 109 receives position/posture information and the like detected by the information processing apparatus 101 that is an HMD via a network (not shown).

FIG. 2 is a block diagram showing a functional configuration according to the present embodiment included in the information processing apparatus 101 (hereinafter, simply referred to as the HMD 101) that is an HMD.

The HMD 101 includes a user position detection part 201, a user posture detection part 202, an obstacle detection part 203, a movement score calculation part 204, a play area setting part 205, and a notification part 206 as functional constituents.

The user position detection part 201 (first detection unit) acquires position information in the virtual space of the user wearing the HMD 101 from the sensing part 105, and stores the position information as a first user position.

The user posture detection part 202 (second detection unit) acquires posture information in the virtual space of the user wearing the HMD 101 from the sensing part 105, and stores the posture information as a first user posture.

The obstacle detection part 203 (obstacle detection unit) detects an obstacle around the user wearing the HMD 101. There are various types of obstacles such as a wall, a chair, a desk, and a trash box, but a method for specifying an obstacle is not described here. Note that an obstacle in the present embodiment may be detected by the shooting part 106 that is a camera attached to the HMD 101, or may be detected by using an external second camera via the communication part 109. Alternatively, an obstacle may be detected by using the sensing part 105 that is a sensor.

On the basis of information regarding the obstacle detected by the obstacle detection part 203, the movement score calculation part 204 (search unit) searches for a position and an orientation of a new play area that is not covered by the obstacle and the position of the user wearing the HMD 101. A method for searching for a new play area will be described later. In this case, the movement score calculation part 204 (first determination unit/second determination unit) also determines a position (second user position) and a posture (second user posture) of the user wearing the HMD 101 in the new play area. Here, in a case where there is no obstacle, there is no change in the position and orientation of the play area, the first user position and the second user position coincide with each other, and the first user posture and the second user posture coincide with each other. The movement score calculation part 204 (movement score calculation unit) calculates a movement score from the first user position and the second user position. For example, the movement score may be obtained as a distance between the first user position and the second user position. However, the movement score is not limited thereto as long as the movement score has a positive correlation with a distance between the first user position and the second user position. That is, since the shorter the distance between the first user position and the second user position becomes, the smaller the load associated with the movement of the user becomes, the movement score calculation part 204 calculates a smaller value of the movement score as the distance between the first user position and the second user position becomes shorter. Furthermore, since a load on the user decreases as a change difference between the first user posture and the second user posture decreases, the movement score calculation part 204 may calculate a smaller value of the movement score as the change difference between the first user posture and the second user posture decreases. That is, the movement score may also have a positive correlation with a change difference between the first user posture and the second user posture.

The play area setting part 205 (play area setting unit) sets the play area according to the movement score calculated by the movement score calculation part 204.

The notification part 206 (notification unit) displays various messages on the display part 107 and displays the play area set by the play area setting part 205 on the display part 107. Note that the movement score calculation part 204 may only search for a new play area without calculating the movement score. In this case, when the movement score calculation part 204 searches for a plurality of new play area candidates, the notification part 206 may display the candidates on the display part 107 in a user-switchable manner and cause the user to select one of the candidates as a new play area.

FIG. 4 is a flowchart showing a play area search process according to the present embodiment. The process shown in this flowchart is realized by the CPU 102 reading a program stored in the ROM 103 into the RAM 104 and executing the program. An execution timing of this process is not limited. The execution timing may be, for example, a timing at which the user wearing the HMD 101 (hereinafter, simply referred to as a user) starts the content, or may be a timing at which the operation part 108 detects a predetermined user operation. First, in step S401, the user position detection part 201 acquires a first user position.

Next, in step S402, the user posture detection part 202 acquires a first user posture.

Next, in step S403, the play area setting part 205 sets a play area on the basis of the first user position and the first user posture, and the obstacle detection part 203 determines whether or not an obstacle in the real space has been detected from the set play area. In this case, the notification part 206 may notify the user to look around so that a wide region around the user can be searched. In a case where an obstacle is detected from the play area (YES in step S403), the process proceeds to step S404, and in a case where an obstacle is not detected from the play area (NO in step S403), the process proceeds to step S407. In this case, in step S407, the notification part 206 displays on the display part 107 the play area set by the play area setting part 205 in step S406.

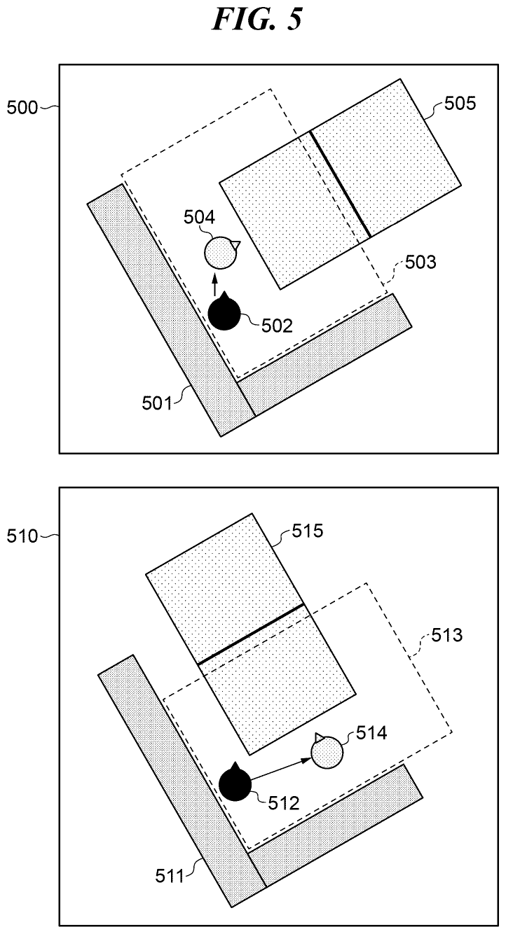

Next, in step S404, the movement score calculation part 204 calculates a movement score by using the method described above. Here, a method of searching for a new play area will be described with reference to FIGS. 3 and 5. Each of an image 300 in FIG. 3 and images 500 and 510 in FIG. 5 is an image in which the user is viewed from above. The user 302 in FIG. 3, and a user 502 and a user 512 in FIG. 5 are the same person, and a position of any user corresponds to the first user position. In addition, the wall 301 in FIG. 3, and a wall 501 and a wall 511 in FIG. 5 correspond to the same wall in the real space. Here, as shown in FIG. 3, in a case where the play area is set on the basis of the first user position and the first user posture, since the wall 301 is present as an obstacle in the play area 304, the user may collide with the wall 301 during the game. In order to avoid this, the movement score calculation part 204 searches for a position and an orientation of a new play area.

The image 500 in FIG. 5 is an example in which the play area 304 in FIG. 3 is rotated and moved clockwise horizontally in parallel. In this case, the play area 304 (FIG. 3) is rotated and moved so that the wall 501 does not enter the new play area 503. Furthermore, a position and an orientation of a virtual table tennis table 505, a position of a second user 504 (second user position), and a posture of the second user 504 (second user posture) are determined, and a movement score 1 is calculated.

On the other hand, the image 510 in FIG. 5 is an example in which the play area 304 in FIG. 3 is rotated and moved counterclockwise horizontally in parallel. In this case, the play area 304 (FIG. 3) is rotated and moved so that the wall 511 does not enter the new play area 513. Furthermore, a position and an orientation of a virtual table tennis table 515, a position of a second user 514 (second user position), and a posture of the second user 514 (second user posture) are determined, and a movement score 2 is calculated.

Note that the movement score calculated by the movement score calculation part 204 in step S404 is stored in the RAM 104 together with the corresponding new play area.

Returning to FIG. 4, next, in step S405, the play area setting part 205 determines whether or not the movement score calculated in step S404 is smaller than a threshold stored in advance in the ROM 103. Note that a movement score that is a determination target here may be all movement scores calculated by the movement score calculation part 204, may be some extracted from the movement scores, or may be only a movement score having the minimum value.

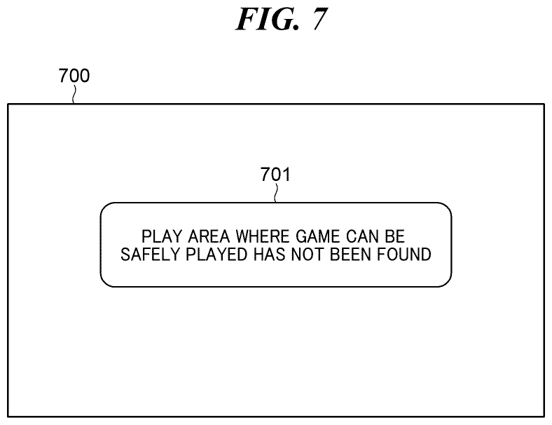

In a case where the movement score that is a determination target is smaller than the threshold (YES in step S405), it is determined that a new play area has been found, and the process proceeds to step S406. On the other hand, in a case where the movement score that is a determination target is the threshold or more (NO in step S405), it is determined that no new play area has been found, and the process proceeds to step S407. In this case, in step S407, the notification part 206 displays, on the display part 107, a message (for example, a message 701 in FIG. 7) for presenting to the user that no play area where the game play can be safely performed has been found.

Next, in step S406, the play area setting part 205 sets a new play area stored in the RAM 104 in association with a movement score smaller than the threshold as a play area used in the VR content, and proceeds to step S407. In this case, in step S407, the notification part 206 displays the play area set in step S406 on the display part 107 in order to present the play area to the user.

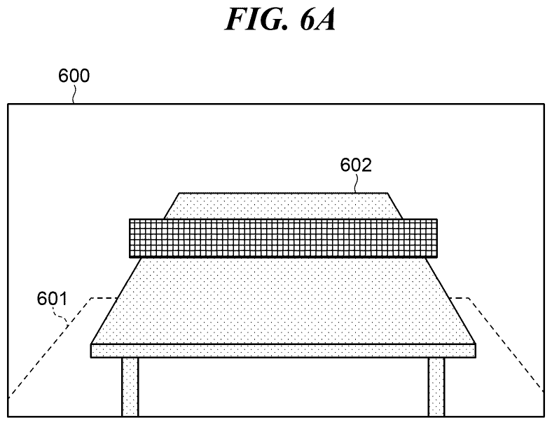

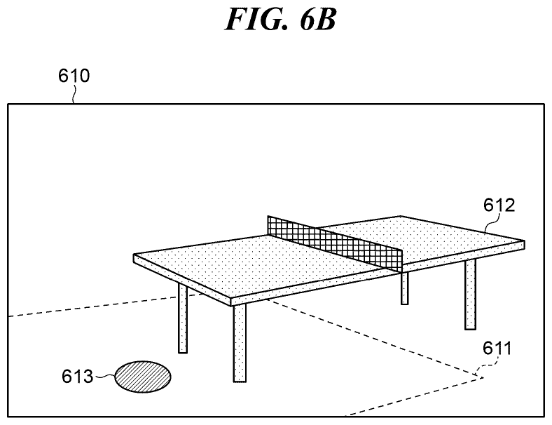

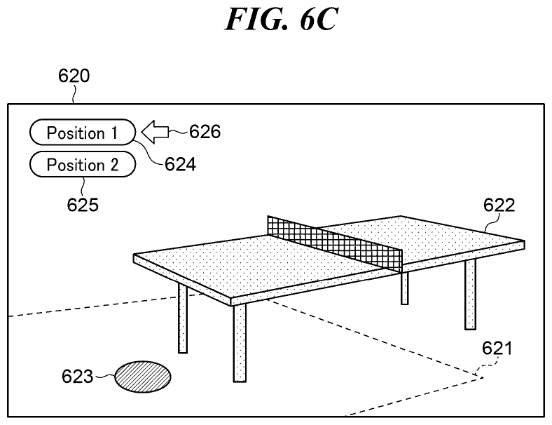

Processing in the case of transition from step S406 to step S407 will be described with reference to FIGS. 6A to 6C. Hereinafter, display on the HMD 101 by the display part 107 will be referred to as HMD display.

Each of HMD displays 600, 610, and 620 in FIGS. 6A to 6C is an example of HMD display of the play area set in step S406.

The HMD display 600 in FIG. 6A is an example of HMD display in a case where the first user position and the second user position are the same, that is, in a case where there is no obstacle at the initial position of the user (NO in step S403). A play area 601 and a virtual table tennis table 602 are displayed in the HMD display 600, and the user can immediately start game play without moving. Therefore, the display part 107 may display a message (not shown) for inquiring whether or not to start the game play to be superimposed on the HMD display 600.

The HMD display 610 in FIG. 6B is an example of HMD display in a case where it is determined in step S405 that a single candidate for a new play area has been found. In the HMD display 610, the single new play area found in step S405 is displayed as a play area 611, and a virtual table tennis table 612 and a second user position 613 are displayed. The user may start the game play by moving to the second user position 613. Thus, the display part 107 may highlight the second user position 613 through blinking display or the like, and display a message (not shown) for notifying the user to move to the blinking display position to be superimposed on the HMD display 610.

The HMD display 620 in FIG. 6C is an example of HMD display in a case where it is determined in step S405 that a plurality of candidates for a new play area have been found. In the HMD display 620, there are UI buttons 624 and 625 that are user interfaces for displaying respective candidates on the display part 107, and an arrow 626 indicating a candidate currently displayed on the display part 107. The arrow 626 indicates the candidate “Position1” associated with the UI button 624, and the play area 621, a virtual table tennis table 622, and a second user position 623 of the candidate “Position1” are displayed on the display part 107. The user can switch and select one of the UI buttons 624 and 625 by using, for example, an operation part 108, an external controller, or through a tap operation based on hand tracking. The display part 107 displays information associated with each candidate according to the selected UI button.

Returning to FIG. 4, after the user notification in step S407, the HMD 101 ends the process in the flowchart of FIG. 4.

It should be noted that, in the present embodiment, the methods for detecting an obstacle and setting a play area in the two-dimensional space in the horizontal direction have been described. However, obstacle detection and play area setting may be performed in a three-dimensional space including a vertical direction. Furthermore, a shape of a play area may be changed according to a situation and the type of VR content.

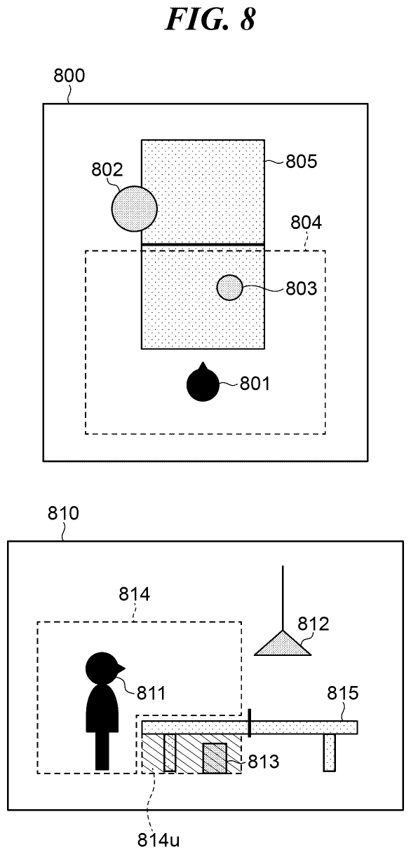

FIG. 8 is a diagram showing an example of an obstacle and a play area in a three-dimensional space including the vertical direction. In FIG. 8, an image 800 is an image in which a user is viewed from above, and an image 810 is an image in which the user is viewed from the right side.

A user 801 and a user 811 are the same person. A light 802 and a light 812 are the same obstacle present in the real space, and a trash box 803 and a trash box 813 are the same obstacle present in the real space. In addition, a play area 804 and a play area 814 indicate the same area, and a table tennis table 805 and a table tennis table 815 are the same virtual object. A height of the play area 814 is preferably set such that the tip of a racket or the like gripped by the user 811 is within the play area 814 even when the user 811 holds the racket or an external controller and raises his/her hand directly upward. Furthermore, since the normal user 811 does not enter a space 814u under the virtual table tennis table 815 during the game play, the space 814u is excluded from the space of the play area 814. Accordingly, the trash box 803 looks like being in the play area 804 when viewed from above as in the image 800, but the trash box 813 is not in the play area 814 when viewed from right beside as in the image 810. Therefore, in the case of FIG. 8, there is no obstacle in the play area, and the user can comfortably play the game.

As described above, according to the present embodiment, a play area can be efficiently set without an operation of a user by using an obstacle in the real space and position/posture information of the user.

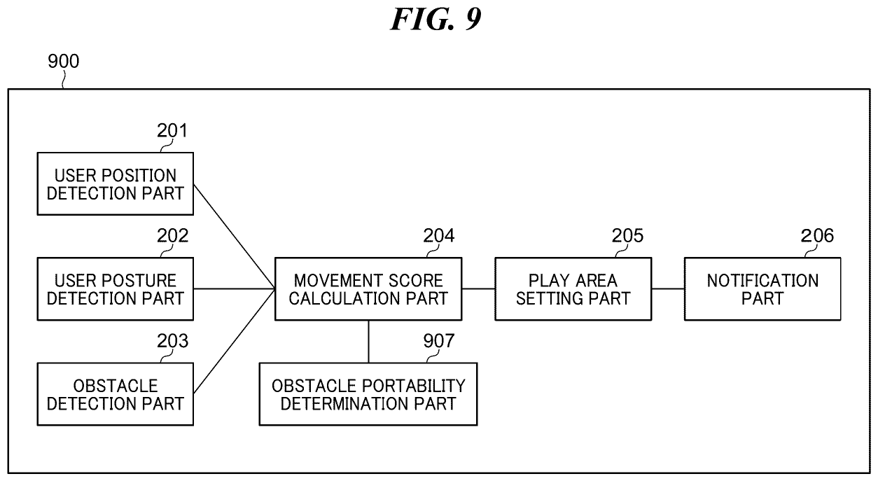

An HMD 101 according to a second embodiment will be described with reference to FIGS. 9 to 12.

Since the HMD 101 according to the second embodiment has a hardware configuration similar to that of the HMD 101 according to the first embodiment, redundant description will be omitted.

The HMD 101 according to the first embodiment compares a movement score with a threshold set in advance, and in a case where it is determined that no new play area has been found on the basis of a comparison result, a user is notified of that effect. In contrast, even in a case where a new play area has not been found, when it is determined that an obstacle is movable, the HMD 101 according to the second embodiment suggests movement of the obstacle to a user, and sets a new play area on the basis of a state of the real space after the movement of the obstacle by the user.

FIG. 9 is a block diagram showing a functional configuration of the HMD 101 according to the present embodiment.

The HMD 101 includes, as functional constituents, a user position detection part 201, a user posture detection part 202, an obstacle detection part 203, a movement score calculation part 204, a play area setting part 205, a notification part 206, and an obstacle portability determination part 907. That is, in the HMD 101 according to the present embodiment, the obstacle portability determination part 907 is added to the function (FIG. 2) of the HMD 101 according to the first embodiment.

The obstacle portability determination part 907 (obstacle portability determination unit) determines whether an obstacle detected by the obstacle detection part 203 has portability or not, and stores a determination result. In the case of the present embodiment, the portability may be determined on the basis of object information (size and type) registered in advance, or may be determined by using a trained model (not shown) registered in advance in the HMD 101.

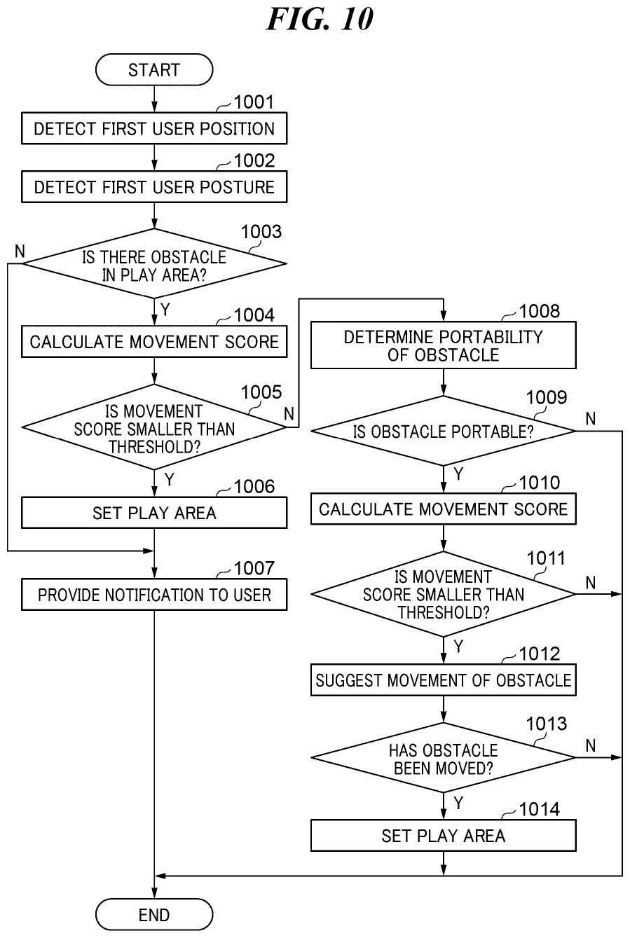

FIG. 10 is a flowchart showing a play area search process according to the second embodiment of the present invention. The process shown in this flowchart is realized by the CPU 102 reading a program stored in the ROM 103 into the RAM 104 and executing the program. An execution timing of this process is not limited. For example, the execution timing may be, for example, a timing at which a user starts the content or may be a timing at which the operation part 108 detects a predetermined user operation.

Since the processes in steps S1001 to S1007 are similar to the processes in steps S401 to S407 shown in FIG. 4, the description thereof will be omitted. However, in FIG. 4, in a case where the movement score that is a determination target is the threshold or more (NO in step S405), the process proceeds to step S407, but in FIG. 10, in a case where the movement score that is a determination target is the threshold or more (NO in step S1005), the process proceeds to step S1008.

In step S1008, the obstacle portability determination part 907 determines whether the obstacle detected in step S1003 has portability or not.

Next, in step S1009, as a result of the determination in step S1008, in a case where the detected obstacle has portability, the movement score calculation part 204 proceeds to step S1010. On the other hand, as a result of the determination in step S1008, in a case where all the detected obstacles have no portability, it is determined that a play area where the obstacles can be avoided cannot be secured, and the process in the flowchart of FIG. 10 is ended.

Next, in step S1010, the movement score calculation part 204 calculates a movement score in a case where it is assumed that there is no obstacle having portability among the detected obstacles by using the method described in step S404 in FIG. 4.

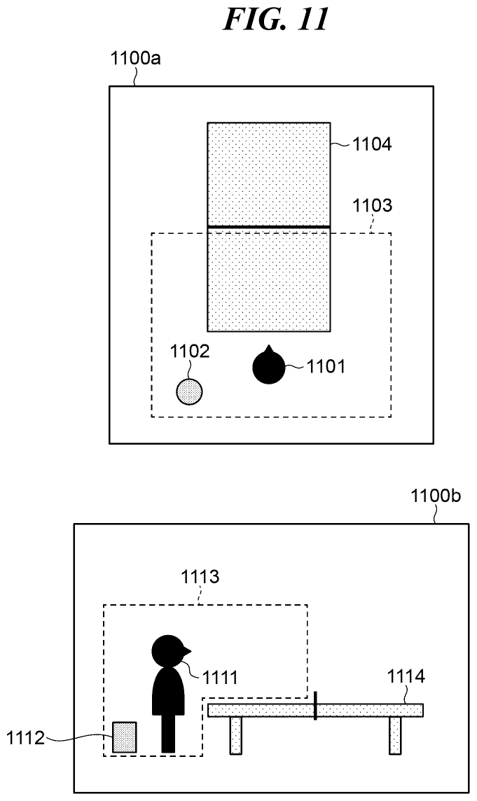

With reference to FIG. 11, a play area in a case where there is a portable obstacle as a result of the determination in step S1008 will be described.

FIG. 11 is a diagram showing an example of an obstacle and a play area in a three-dimensional space including a vertical direction. In FIG. 11, an image 1100a is an image in which a user is viewed from above, and an image 1110b is an image in which the user is viewed from right beside.

A user 1101 and a user 1111 are the same person. A trash box 1102 and a trash box 1112 are the same obstacle present in the real space. In addition, a play area 1103 and a play area 1113 indicate the same region, and a table tennis table 1104 and a table tennis table 1114 are the same virtual object.

In the case of FIG. 11, an obstacle in the play area detected in step S1003 is only the trash box 1112, and it is determined in step S1008 that trash box 1112 has portability. In this case, in step S1010, assuming that the user moves the trash box 1112 to the outside of the play area 1113 and assuming that the trash box 1112 is not present, the movement score is calculated by using the method described in step S404 in FIG. 4. In step S1003, not only a portable obstacle (for example, a trash box) but also a non-portable obstacle (for example, a wall) may be detected in the play area. In this case, in step S1010, it is assumed that there is no portable obstacle among the detected obstacles and only a non-portable obstacle is an obstacle in the play area, and a movement score is calculated by using the method described in step S404 in FIG. 4.

Returning to FIG. 10, next, in step S1011, the play area setting part 205 determines whether or not the movement scores calculated in step S1010 are smaller than a threshold stored in advance in the ROM 103. Note that a movement score that is a determination target here may be all movement scores, may be some extracted from all the movement scores, or may be only a movement score having the minimum value.

When the movement score that is a determination target is smaller than the threshold (YES in step S1011), it is determined that a new candidate for the play area has been found, and the process proceeds to step S1012. On the other hand, in a case where the movement score that is a determination target is the threshold or more (NO in step S1011), it is determined that no new candidate for the play area has been found, and the process in the flowchart of FIG. 10 is ended.

Next, in step S1012, the notification part 206 suggests movement of the obstacle determined to be portable to the user.

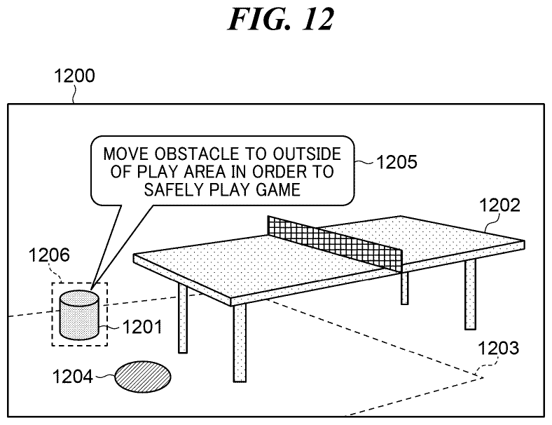

Hereinafter, HMD display 1200 in FIG. 12, which is an example of the user suggestion method in step S1012, will be described. In the HMD display 1200 in FIG. 12, the display part 107 includes a trash box 1201 in the real space, a table tennis table 1202 in the virtual space, a play area 1203, a second user position 1204, a message 1205, and a display frame 1206. The trash box 1201 is an obstacle in the real space determined to be portable by the obstacle portability determination part 907, and a video of the trash box 1201 in the real space is superimposed and displayed on the virtual space. The display frame 1206 is display of decoration for attracting attention of the user to the trash box 1201, and the attention degree may be increased through blinking or animation. The message 1205 is a message box for presenting, to the user, a notification for requesting the user to move the trash box 1201 to the outside of the play area 1203.

Returning to FIG. 10, next, in step S1013, the play area setting part 205 determines whether or not the user has moved all the portable obstacles to the outside of the candidate play area. In a case where the user has moved all the portable obstacles to the outside of the candidate play area (YES in step S1013), it is determined that the candidate play area is a play area where the collision between the user and the obstacle can be avoided, and the process proceeds to step S1014. On the other hand, in a case where the user has not moved all the portable obstacles to the outside of the candidate play area (NO in step S1013), it is determined that a play area where the collision between the user and the obstacle can be avoided cannot be confirmed, and the process in the flowchart of FIG. 10 is ended. In this case, before the process is ended, the process may return to step S1012, and the notification part 206 may suggest the movement of the obstacle determined to be portable to the user.

Next, in step S1014, the play area setting part 205 sets the candidate play area as a play area used in the VR content, and ends the process in the flowchart of FIG. 10.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017795, filed Feb. 8, 2024 which is hereby incorporated by reference wherein in its entirety.

What is claimed is:

1. An information processing apparatus that displays a virtual space on a head mounted display worn by a user, the information processing apparatus comprising one or more processors and/or circuitry configured to:
execute a first detection process of detecting position information of the user in the virtual space as a first user position;
execute a second detection process of detecting posture information of the user in the virtual space as a first user posture;
execute a play area setting process of setting a play area on the basis of the first user position and the first user posture;
execute an obstacle detection process of detecting an obstacle in a real space in the play area;
execute a search process of searching for a new play area on the basis of a position of the detected obstacle; and
execute a notification process of displaying the new play area on the head mounted display.

2. The information processing apparatus according to claim 1, wherein, in the search process, the new play area is determined so that the obstacle does not enter the new play area.

3. The information processing apparatus according to claim 1, wherein the one or more processors and/or circuitry is/are configured to
execute a first determination process of determining a second user position that is a position of the user in the new play area.

4. The information processing apparatus according to claim 3, wherein,
in the notification process, the second user position is displayed on the head mounted display together with the new play area.

5. The information processing apparatus according to claim 3, wherein the one or more processors and/or circuitry is/are configured to execute a movement score calculation process of calculating a movement score having a positive correlation with a distance between the first user position and the second user position, and
in a case where the movement score is a threshold or more, in the notification process, a notification that there is no play area where game play can be safely performed is provided without displaying the new play area on the head mounted display.

6. The information processing apparatus according to claim 5, wherein
in a case where a plurality of play areas having the movement score smaller than the threshold, which are candidates for the new play area, are searched for in the search process, a play area having the smallest movement score among the play areas that have been searched for is set as the new play area.

7. The information processing apparatus according to claim 5, wherein
in a case where a plurality of play areas having the movement score smaller than the threshold, which are candidates for the new play area, are searched for in the search process, in the notification process, the play areas that have been searched for are displayed on the head mounted display in a switchable manner as the candidates for the new play area.

8. The information processing apparatus according to claim 5, wherein the one or more processors and/or circuitry is/are configured to execute a second determination process of determining a second user posture that is a posture of the user in the new play area, and
the movement score further has a positive correlation with a change difference between the first user posture and the second user posture.

9. The information processing apparatus according to claim 1, wherein the one or more processors and/or circuitry is/are configured to execute an obstacle portability determination process of determining portability of the detected obstacle, and
in the search process, the new play area is searched for assuming that there is no obstacle determined to be portable by the obstacle portability determination process among the detected obstacles.

10. The information processing apparatus according to claim 9, wherein,
in the notification process,
a video of an obstacle determined to be portable in the obstacle portability determination process is displayed in a real space to be superimposed on the virtual space, and
a message for requesting movement of the obstacle determined to be portable in the obstacle portability determination process is displayed on the head mounted display.

11. The information processing apparatus according to claim 10, wherein, in the notification process, display for decorating the video displayed to be superimposed on the virtual space is displayed on the head mounted display.

12. The information processing apparatus according to claim 1, wherein, in the obstacle detection process, the obstacle in a two-dimensional space in a horizontal direction is detected.

13. The information processing apparatus according to claim 1, wherein, in the obstacle detection process, the obstacle in a three-dimensional space in a horizontal direction and a vertical direction is detected.

14. The information processing apparatus according to claim 13, wherein, in the obstacle detection process, a space that the user does not enter during game play is excluded from the play area.

15. An information processing method for an information processing apparatus that displays a virtual space on a head mounted display worn by a user, the information processing method comprising:
a first detection step of detecting position information of the user in the virtual space as a first user position;
a second detection step of detecting posture information of the user in the virtual space as a first user posture;
a setting step of setting a play area on the basis of the first user position and the first user posture;
an obstacle detection step of detecting an obstacle in a real space in the play area;
a search step of searching for a new play area on the basis of a position of the detected obstacle; and
a notification step of displaying the new play area on the head mounted display.

16. A non-transitory storage medium storing a program for causing a computer to execute information processing method for an information processing apparatus that displays a virtual space on a head mounted display worn by a user,
the information processing method for the information processing apparatus, comprising:
a first detection step of detecting position information of the user in the virtual space as a first user position;
a second detection step of detecting posture information of the user in the virtual space as a first user posture;
a setting step of setting a play area on the basis of the first user position and the first user posture;
an obstacle detection step of detecting an obstacle in a real space in the play area;
a search step of searching for a new play area on the basis of a position of the detected obstacle; and
a notification step of displaying the new play area on the head mounted display.
